(19) United States
(12) Patent Application Publication
(10) Pub. No.: US 2017/0096904 A1
(43) Pub. Date: Apr. 6, 2017

(54) ROTARY MACHINE AND NOZZLE ASSEMBLY THEREFOR

(71) Applicant: General Electric Company, Schenectady, NY (US)

(72) Inventors: Manish Mahasukhrai Joshi, Rugby (GB); David Orus Fitts, Ballston Spa, NY (US); Robert Edward Deallenbach, Flat Rock, NC (US)

(21) Appl. No.: 15/383,947

(22) Filed: Dec. 19, 2016

Related U.S. Application Data
(63) Continuation-in-part of application No. 13/614,297, filed on Sep. 13, 2012.

(51) Int. Cl. F01D 9/04; F01D 25/24

(52) U.S. Cl. CPC F01D 9/042; F01D 9/041; F01D 25/246; F05D 2220/31; F05D 2260/30; F05D 2240/128

(57) ABSTRACT

A rotary machine is provided. The rotary machine includes a turbine section with a casing and a ring coupled within the casing. The ring has a groove. The rotary machine also includes a nozzle coupled to the ring. The nozzle has a first end, a second end, and an airfoil extending between the first end and the second end along a longitudinal axis. The first end includes a first hook and a second hook. The first hook has a first radially outer surface, and the second hook has a second radially outer surface. The ring and the first end of the nozzle cooperate to form an anti-rotation feature that extends from at least one of the radially outer surfaces along the axis and between the hooks.

### CROSS-REFERENCE TO RELATED APPLICATIONS

This application claims the benefit of U.S. Non-Provisional application Ser. No. 13/614,297 filed on Sep. 13, 2012, which is incorporated by reference herein in its entirety.

### BACKGROUND

The field of this disclosure relates generally to rotary machines and, more particularly, to nozzle assemblies for rotary machines.

At least some known rotary machines (e.g., steam turbine engines) include a ring and a plurality of stationary nozzles coupled to the ring such that the nozzles channel a flow of heated fluid (e.g., steam). It is common to install each nozzle in a pre-twisted state to induce an interference fit amongst the nozzles along the ring, which in turn maintains a circumferential alignment of the nozzles about the ring, reduces steam leakage, and provides coupling between nozzles to reduce potential vibratory responses, such as to a bucket passing frequency.

However, as a result of the heated fluid flowing through the ring during operation of the rotary machine, the ring and the nozzles can be exposed to elevated temperatures and pressure gradients that cause the ring to experience high temperature creep, which can in turn cause the ring to deform at its interface with the nozzles. This can loosen the engagement between ring and the nozzles, thereby making the nozzles more susceptible to rotation in response to their pre-twisted bias. When the nozzles are permitted to rotate, the interference fit amongst the nozzles can be altered, which can in turn render the nozzles more susceptible to steam leakage and potentially increased fatigue. The displacement (or removal) of nozzles relative to the ring during operation of the rotary machine can reduce operating efficiency and/or damage the rotary machine.

### BRIEF DESCRIPTION

In one aspect, a rotary machine is provided. The rotary machine includes a turbine section with a casing and a ring coupled within the casing. The ring has a groove. The rotary machine also includes a nozzle coupled to the ring. The nozzle has a first end, a second end, and an airfoil extending between the first end and the second end along a longitudinal axis. The first end includes a first hook and a second hook. The first hook has a first radially outer surface, and the second hook has a second radially outer surface. The ring and the first end of the nozzle cooperate to form an anti-rotation feature that extends from at least one of the radially outer surfaces along the axis and between the hooks.

In another aspect, a nozzle assembly for a rotary machine is provided. The nozzle assembly includes a ring having a groove. The nozzle assembly also includes a nozzle coupled to the ring. The nozzle has a first end, a second end, and an airfoil extending between the first end and the second end along a longitudinal axis. The first end includes a first hook and a second hook. The first hook has a first radially outer surface, and the second hook has a second radially outer surface. The ring and the first end of the nozzle cooperate to form an anti-rotation feature that extends from at least one of the radially outer surfaces along the axis and between the hooks.

In another aspect, a nozzle for a rotary machine is provided. The nozzle includes a first end, a second end, and an airfoil extending between the first end and the second end along a longitudinal axis. The first end includes a first hook and a second hook. The first hook has a first radially outer surface, and the second hook has a second radially outer surface. The first end includes one of a lug and a notch having an anti-rotation surface extending from at least one of the first radially outer surface and the second radially outer surface along the axis and between the hooks.

### BRIEF DESCRIPTION OF THE DRAWINGS

FIG. 1 is a schematic illustration of an exemplary rotary machine;

FIG. 2 is a schematic illustration of a high pressure (HP) section of the rotary machine shown in FIG. 1;

FIG. 3 is a perspective view of a ring segment of the HP section shown in FIG. 2 with a plurality of nozzles coupled thereto;

FIG. 4 is a schematic illustration of a portion of a nozzle assembly of the HP section shown in FIG. 2 and taken within area 4 of FIG. 2;

FIG. 5 is a schematic illustration of a portion of an alternative nozzle assembly for use with the HP section shown in FIG. 2;

FIG. 6 is a schematic illustration of a portion of another alternative nozzle assembly for use with the HP section shown in FIG. 2; and

FIG. 7 is a schematic illustration of a portion of another alternative nozzle assembly for use with the HP section shown in FIG. 2.

### DETAILED DESCRIPTION

The following detailed description illustrates a rotary machine by way of example and not by way of limitation. The description should enable one of ordinary skill in the art to make and use the rotary machine, and the description describes several embodiments of the rotary machine, including what is presently believed to be the best modes of making and using the rotary machine. Exemplary rotary machines are described herein as being useful as turbine engines. However, it is contemplated that the rotary machines have general application to a broad range of systems in a variety of fields other than turbine engines.

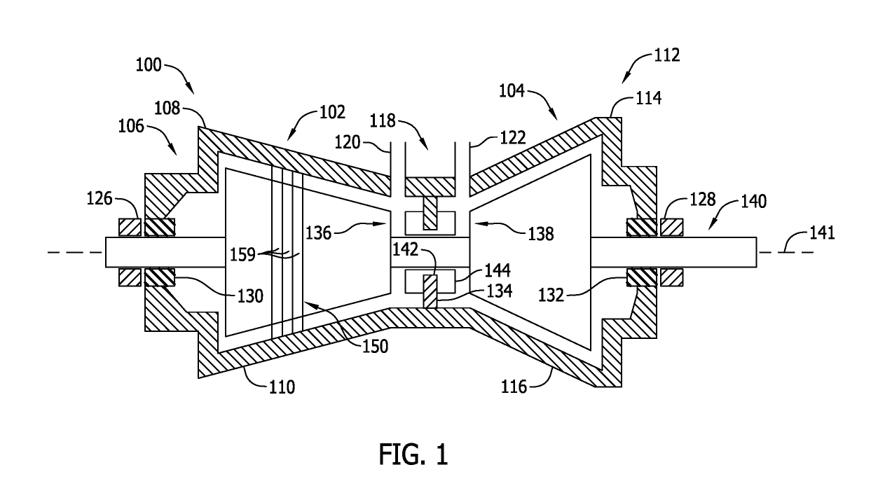

FIG. 1 is a schematic illustration of an exemplary rotary machine 100. In the exemplary embodiment, rotary machine 100 is an opposed-flow steam turbine engine that includes a high pressure (HP) section 102, an intermediate pressure (IP) section 104, and a central section 118 that extends between HP section 102 and IP section 104. Central section 118 has an inlet 120 for channeling high pressure steam to HP section 102, and central section 118 also has an inlet 122 for channeling intermediate pressure steam to IP section 104. While rotary machine 100 is an opposed-flow steam turbine engine having HP section 102 and IP section 104, rotary machine 100 may have any other suitable number of section(s) including, but not limited to, a low pressure (LP) section. In other embodiments, rotary machine 100 is not limited to being an opposed-flow steam turbine engine but, rather, rotary machine 100 may have any suitable type of turbine engine configuration including, but not limited to, a single-flow configuration or a double-flow configuration. Alternatively, although rotary machine 100 is illustrated as being a turbine engine in the exemplary embodiment, rotary machine 100 is not limited to being a turbine engine, and one of ordinary skill in the art will appreciate that the present disclosure is useful for various other types of rotary machines.

In the exemplary embodiment, rotary machine 100 has a rotor shaft 140 that extends along a rotor axis 141, and is partly enclosed by a casing 106 of HP section 102, and a casing 112 of IP section 104. Casing 106 has an upper half section 108 and a lower half section 110 that oppose one another across axis 141. Similarly, casing 112 has an upper half section 114 and a lower half section 116 that oppose one another across axis 141. Although casings 106 and 112 are inner casings in the exemplary embodiment, casings 106 and 112 may be outer casings in other embodiments. In its extension through casings 106 and 112, rotor shaft 140 is supported by respective journal bearings 126 and 128, and steam seal assemblies 130 and 132 are coupled inboard of each respective journal bearing 126 and 128.

In the exemplary embodiment, an annular section divider 134 extends radially inwardly at central section 118 and towards rotor shaft 140. Divider 134 circumscribes a portion of rotor shaft 140 between an inlet nozzle 136 of HP section 102 and an inlet nozzle 138 of IP section 104, and divider 134 is at least partially inserted into a channel 142 defined in a packing casing 144. More specifically, channel 142 is a C-shaped channel, and divider 134 extends substantially radially into packing casing 144 around an outer circumference of packing casing 144 such that a center opening (not shown) of channel 142 faces radially outwardly.

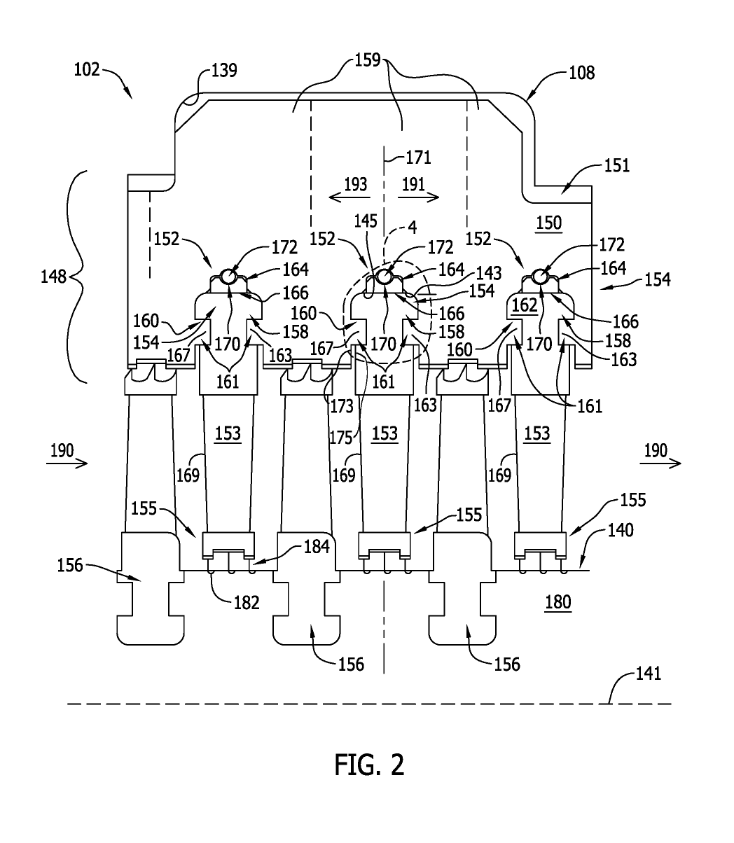

During operation of rotary machine 100, inlet 120 receives high pressure (and high temperature) steam from a steam source, such as a boiler (not shown). The steam is channeled through HP section 102 via inlet nozzle 136, wherein the steam flows across a plurality stationary nozzles 153 (shown in FIG. 2) and drives a plurality of rotor blades (or buckets) 156 (shown in FIG. 2) that are coupled to rotor shaft 140, thereby inducing rotation of rotor shaft 140. The steam then exits HP section 102 and is returned to the steam source, wherein the steam is reheated. The reheated steam is then channeled through IP section 104 via inlet 122 at a lower pressure, but approximately the same temperature, as the steam entering HP section 102. Because an operating pressure of the steam within HP section 102 is higher than an operating pressure of the reheated steam within IP section 104, the steam within HP section 102 may flow towards IP section 104 via leakage paths (not shown) defined between HP section 102 and IP section 104. Notably, work is extracted from the reheated steam in IP section 104 in a manner substantially similar to that of HP section 102 (i.e., by driving a plurality of rotor blades (not shown) of IP section 104 to induce rotation of rotor shaft 140).

FIG. 2 is a schematic illustration of HP section 102 of rotary machine 100. Although embodiments of the disclosure are illustrated with respect to HP section 102, it should be understood that embodiments of the disclosure are also applicable to any suitable section of any suitable rotary machine, such as but not limited to IP section 104 and/or a low pressure (LP) section. In the exemplary embodiment, HP section 102 includes at least one nozzle assembly 148 having a substantially annular outer (or blinglet) ring 150 that substantially circumscribes rotor shaft 140, and at least one stationary nozzle 153 coupled to ring 150. Each nozzle 153 includes a first end (or dovetail) 154, a second end (or cover) 155, and an airfoil (or vane) 169 extending from first end 154 to second end 155. First end 154 includes a first hook 158 having a radially outer surface 143, and a second hook 160 having a radially outer surface 145.

A top half 151 of ring 150 is mated against radially inner surfaces 139 of upper half section 108 of casing 106, such that ring top half 151 serves as a radially inward extension of casing 106. This mating relationship facilitates maintaining ring top half 151 in a substantially fixed position with respect to rotor shaft 140. As such, in the exemplary embodiment, rotor shaft 140 includes a rotor surface 180 having a plurality of substantially annular rotor grooves 182 formed therein. At least one substantially arcuate sealing strip 184 is securely coupled within each rotor groove 182. Moreover, the second end 155 of each nozzle 153 is positioned adjacent to sealing strips 184, such that sealing strips 184 substantially reduce an amount of fluid leakage that may occur between rotor shaft 140 and casing 106.

In the exemplary embodiment, top half 151 of ring 150 has at least one groove 152, and each groove 152 receives at least a portion of at least one nozzle 153 therein (i.e., first end 154). Ring 150 also has a plurality of adjacent ring segments 159, each of which has a pair of circumferentially extending ligaments 161 that axially oppose one another to define a respective one of the grooves 152 therebetween. More specifically, a first ligament 163 extends radially inward of first hook 158, and a second ligament 167 extends radially inward of second hook 160 to facilitate maintaining an axial and radial position of each nozzle 153 relative to rotor shaft 140.

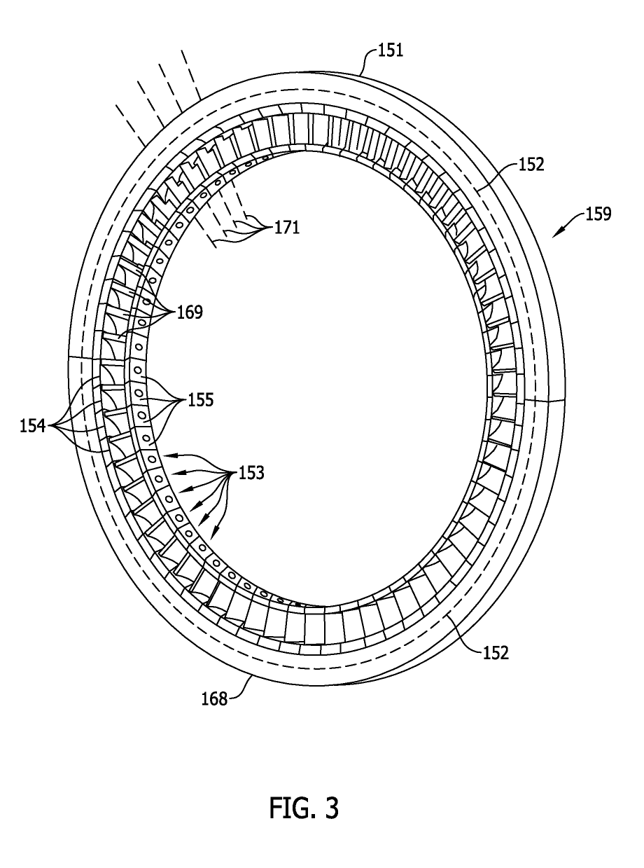

FIG. 3 is a perspective view of a ring segment 159 with a plurality of nozzles 153 coupled thereto. In the exemplary embodiment, a bottom half 168 of ring 150 is coupled to top half 151, and ring bottom half 168 receives nozzles 153 in a manner similar to that of ring top half 151, as set forth in more detail below. Ring bottom half 168 mates with lower half section 110 of casing 106 (shown in FIG. 1), such that ring bottom half 168 serves as a radially inward extension of casing 106. This mating relationship facilitates maintaining bottom half 168 in a substantially fixed position with respect to rotor shaft 140.

With reference to FIGS. 2 and 3, each nozzle 153 is coupled to ring top half 151 by inserting first end 154 (i.e., first hook 158 and second hook 160) into the respective groove 152, and sliding the nozzle 153 along groove 152 and into abutment with the first end 154 of a circumferentially adjacent nozzle 153 that has already been inserted into groove 152. The second end 155 of the nozzle 153 is then rotated about a longitudinal axis 171 of the nozzle 153 to align the second end 155 of the nozzle 153 with the second end 155 of the adjacent nozzle 153. Because the first end 154 is seated within groove 152, the first end 154 does not rotate together with its associated second end 155, thereby causing airfoil 169 to twist about axis 171 when the second end 155 is rotated. By rotating the second end 155 of each nozzle 153 before sandwiching it between the second ends 155 of adjacent nozzles 153, each airfoil 169 is held in a pre-twisted state during operation of rotary machine 100, which causes each second end 155 to impart a circumferential biasing force against the second ends 155 of its adjacent nozzles 153. This induces an interference fit amongst nozzles 153 along ring 150, which in turn maintains nozzles 153 in a proper circumferential alignment about ring 150, thereby facilitating reduced steam leakage and coupling nozzles 153 such that potential vibratory responses are reduced.

Notably, groove 152 has at least one anti-rotation surface 173 (e.g., a flat surface) that engages at least one corresponding anti-rotation surface 175 (e.g., a flat surface) of each nozzle first end 154 radially inward of at least one of its hooks 158 and 160 to inhibit each first end 154 from rotating in response to the rotation of the corresponding nozzle second end 155 during the pre-twisting operation. By inhibiting each first end 154 from rotating, the pre-twisted state of its associated airfoil 169 can be achieved and maintained during operation of rotary machine 100. However, as a result of steam 190 flowing through HP section 102 during operation of rotary machine 100, nozzle assembly 148 can be exposed to elevated temperatures and pressure gradients that cause ring 150 to experience high temperature creep, which can in turn cause opposing ligaments 163 and 167 of each ring segment 159 to deform away from one another (and, hence, away from the first ends 154 of the nozzles 153) in respective directions 191 and 193 along axis 141. This can loosen the engagement between corresponding anti-rotation surfaces 173 and 175, thereby making first ends 154 more susceptible to rotation in response to the pre-twisted bias of airfoils 169. In that regard, if the first end 154 of even one nozzle 153 is permitted to rotate within groove 152, then the interference fit amongst all nozzles 153 along the groove 152 can be altered, which can in turn render the nozzles 153 more susceptible to steam leakage and increased fatigue. The displacement (or removal) of nozzles 153 relative to ring 150 during operation of rotary machine 100 can damage rotary machine 100, and it is therefore desirable to secure nozzles 153 in a manner that facilitates ensuring that the interference fit and, hence, the relative positioning amongst nozzles 153 does not change under circumstances of high temperature creep. Set forth below are various embodiments that facilitate this objective.

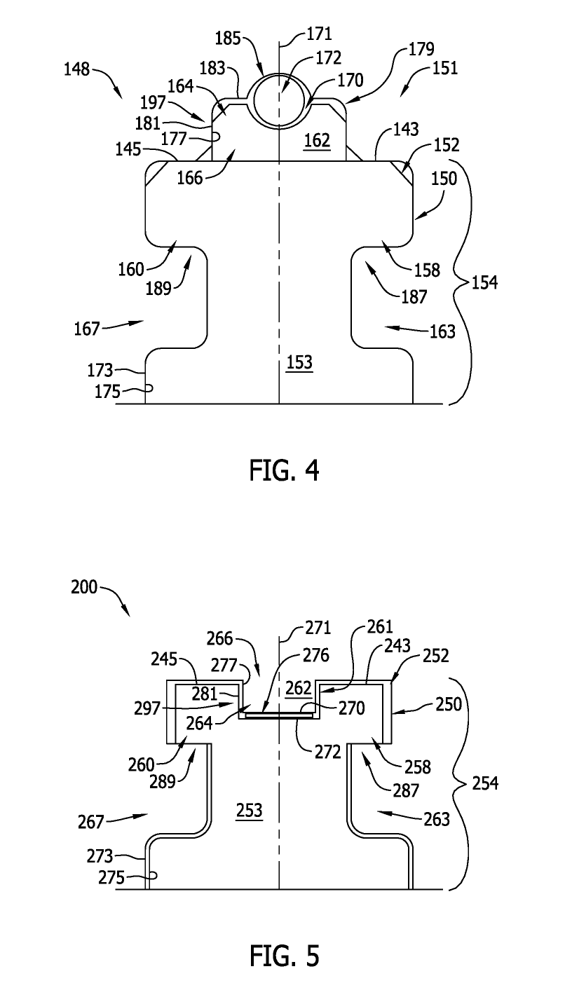

FIG. 4 is a schematic illustration of a portion of nozzle assembly 148 taken within area 4 of FIG. 2. In the exemplary embodiment, to facilitate inhibiting rotation of each nozzle first end 154 when ligaments 163 and 167 respectively deform in directions 191 and 193 (shown in FIG. 2) in response to high temperature creep during operation of rotary machine 100, each nozzle 153 is provided with a coupling portion (or lug) 162 that extends from each nozzle first end 154 (i.e., from radially outer surface(s) 143 and/or 145). Each coupling portion 162 is formed integrally with first end 154 such that first end 154 and coupling portion 162 are a single-piece, unitary structure. Coupling portion 162 may be formed via a variety of manufacturing processes known in the art, such as, but not limited to, a molding process, a drawing process, or a machining process. One or more types of materials may be used to fabricate coupling portion 162 and/or first end 154, with the materials selected based on suitability for one or more manufacturing techniques, dimensional stability, cost, moldability, workability, rigidity, and/or other characteristics of the material(s). For example, coupling portion 162 and/or first end 154 may be fabricated from a metal, such as an alloy steel and/or a nickel based material.

In the exemplary embodiment, each coupling portion 162 has a first end 164, a second end 166, and at least one anti-rotation surface 177 (e.g., a flat surface) that extends from at least one of radially outer surfaces 143 and 145, and between ends 164 and 166, along axis 171. First end 164 defines a radially outwardly facing groove 170 (e.g., an arcuate groove). Likewise, the associated groove 152 of ring 150 includes a circumferentially extending notch 179 sized to receive coupling portion 162. Notch 179 has at least one anti-rotation surface 181 (e.g., a flat surface), and an end surface 183 that defines a radially inwardly facing groove 185 (e.g., an arcuate groove). When nozzle 153 is inserted into groove 152, coupling portion 162 is inserted into notch 179, such that coupling portion anti-rotation surface(s) 177 engage notch anti-rotation surface(s) 181 to form an anti-rotation feature 197 that extends radially outward from radially outer surface(s) 143 and/or 145 along axis 171. Coupling portion groove 170 and notch groove 185 thus align and cooperate to receive an attachment member 172 therebetween (e.g., a generally cylindrical spacer such as, for example, a caulking pin). When attachment member 172 is inserted between coupling portion groove 170 and notch groove 185, attachment member 172 biases nozzle 153 radially inward along axis 171 to seat first hook 158 and second hook 160 against rails 187 and 189 of respective ligaments 163 and 167 to facilitate maintaining a radial position of nozzle 153 relative to rotor shaft 140 during operation of rotary machine 100.

When ring 150 experiences high temperature creep in response to elevated temperatures and pressure gradients as set forth above, the radially inner portions of ligaments 163 and 167 tend to undergo more deformation (e.g., in directions 191 and 193) than do the radially outer portions of ligaments 163 and 167. Therefore, the anti-rotation surfaces of ring 150 that are radially inward (e.g., anti-rotation surface(s) 173) tend to undergo more deformation in directions 191 and 193 than do the anti-rotation surfaces of ring 150 that are radially outward (e.g., anti-rotation surface(s) 181). As a result, even when the engagement between anti-rotation surfaces 173 and 175 loosens due at least in part to high temperature creep, anti-rotation surfaces 177 and 181 remain firmly engaged due at least in part to the radially outward extension of anti-rotation surfaces 177 from radially outer surface(s) 143 and/or 145. This facilitates ensuring that first end 154 does not rotate relative to ring 150 when ring 150 is subjected to high temperature creep, thus maintaining the interference fit amongst second ends 155 to ensure the respective circumferential alignment of nozzles 153 during operation of rotary machine 100.

FIG. 5 is a schematic illustration of a portion of an alternative nozzle assembly 200 for use with HP section 102. In the exemplary embodiment, nozzle assembly 200 includes a substantially annular outer (or blinglet) ring 250 having at least one groove 252 defined therein. Nozzle assembly 200 also includes at least one stationary nozzle 253 having a first end 254 that includes a first hook 258, a second hook 260, and a notch 261 defined between first hook 258 and second hook 260. A coupling portion (or lug) 262 of ring 250 extends into groove 252 and is positioned at least partially within notch 261.

Coupling portion 262 is formed integrally with ring 250 such that coupling portion 262 and ring 250 are a single-piece, unitary structure. Coupling portion 262 may be formed with ring 250 via a variety of manufacturing processes known in the art, such as, but not limited to, a molding process, a drawing process, and/or a machining process. One or more types of materials may be used to fabricate coupling portion 262 and/or ring 250, with the materials selected based on suitability for one or more manufacturing techniques, dimensional stability, cost, moldability, workability, rigidity, and/or other characteristics of the material(s). For example, coupling portion 262 and/or ring 250 may be fabricated from a metal, such as a steel alloy material and/or a nickel-based material.

In the exemplary embodiment, coupling portion 262 has a first end 264 and a second end 266. Coupling portion first end 264 has a substantially planar end surface 270, and nozzle notch 261 has a substantially planar end surface 272 oriented substantially parallel to coupling portion end surface 270. An attachment member 276 (e.g., a plate-shaped spacer) is inserted between surfaces 270 and 272 to bias nozzle 253 radially inward along a longitudinal axis 271 of nozzle 253 to seat first hook 258 and second hook 260 against respective rails 287 and 289 of ligaments 263 and 267 to facilitate maintaining a radial positioning of nozzle 253 during operation of rotary machine 100. Notably, nozzle notch 261 has at least one anti-rotation surface 281 (e.g., a flat surface), and coupling portion 262 has a corresponding anti-rotation surface 277 (e.g., a flat surface). Coupling portion anti-rotation surface(s) 277 engage notch anti-rotation surface(s) 281 to form an anti-rotation feature 297 that extends radially inward from radially outer surface(s) 243 and/or 245 along axis 271.

When ring 250 experiences high temperature creep in response to elevated temperatures and pressure gradients as set forth above, the radially inner portions of ligaments 263 and 267 tend to undergo more deformation (e.g., in directions 191 and 193 of FIG. 2) than do the radially outer portions of ligaments 263 and 267. Therefore, the anti-rotation surfaces of ring 250 that are radially inward (e.g., anti-rotation surface(s) 273) tend to undergo more deformation in directions 191 and 193 than do the anti-rotation surfaces of ring 250 that are radially outward (e.g., anti-rotation surface(s) 277). As a result, even when the engagement between anti-rotation surfaces 273 and 275 loosens due at least in part to high temperature creep, anti-rotation surfaces 277 and 281 remain firmly engaged due at least in part to the radially inward extension of anti-rotation surfaces 281 from radially outer surface(s) 243 and/or 245. This facilitates ensuring that first end 254 does not rotate relative to ring 250 when ring 250 is subjected to high temperature creep, thus maintaining the interference fit amongst nozzles 253 to ensure the respective circumferential alignment of nozzles 253 during operation of rotary machine 100.

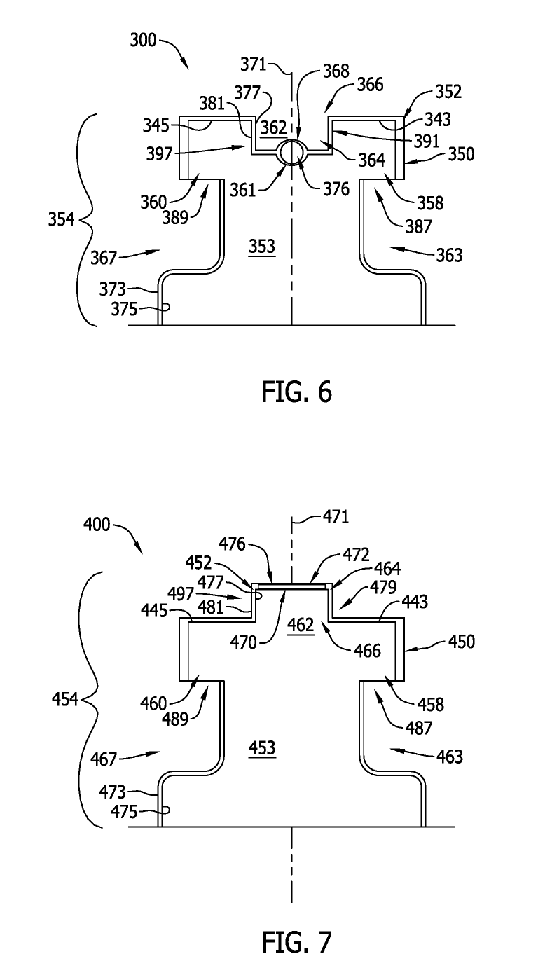

FIG. 6 is a schematic illustration of a portion of another alternative nozzle assembly 300 for use with HP section 102. In the exemplary embodiment, nozzle assembly 300 includes a substantially annular outer (or blinglet) ring 350 having at least one groove 352 defined therein. Nozzle assembly 300 also includes at least one stationary nozzle 353 having an end 354 that includes a first hook 358, a second hook 360, and a notch 391 defined between first hook 358 and second hook 360. A coupling portion (or lug) 362 of ring 350 extends into groove 352 and is positioned at least partially within notch 391.

Coupling portion 362 is formed integrally with ring 350 such that coupling portion 362 and ring 350 are a single-piece, unitary structure. Coupling portion 362 may be formed with ring 350 via a variety of manufacturing processes known in the art, such as, but not limited to, a molding process, a drawing process, and/or a machining process. One or more types of materials may be used to fabricate coupling portion 362 and/or ring 350, with the materials selected based on suitability for one or more manufacturing techniques, dimensional stability, cost, moldability, workability, rigidity, and/or other characteristics of the material(s). For example, coupling portion 362 and/or ring 350 may be fabricated from a metal, such as a steel alloy material and/or a nickel-based material.

In the exemplary embodiment, coupling portion 362 has a first end 364 and a second end 366. Coupling portion first end 364 defines a radially inwardly facing groove 368 (e.g., an arcuate groove), and nozzle notch 391 defines a radially outwardly facing groove 361 (e.g., an arcuate groove). An attachment member 376 (e.g., a generally cylindrical spacer such as, for example, a caulking pin) is inserted between grooves 361 and 368 to bias nozzle 353 radially inward along a longitudinal axis 371 of nozzle 353 to seat first hook 358 and second hook 360 against rails 387 and 389 of respective ligaments 363 and 367 to facilitate maintaining a radial position of nozzle 353 during operation of rotary machine 100. Notably, nozzle notch 391 has at least one anti-rotation surface 381 (e.g., a flat surface), and coupling portion 362 has a corresponding anti-rotation surface 377 (e.g., a flat surface). Coupling portion anti-rotation surface(s) 377 engage notch anti-rotation surface(s) 381 to form an anti-rotation feature 397 that extends radially inward from radially outer surface(s) 343 and/or 345 along axis 371.

When ring 350 experiences high temperature creep in response to elevated temperatures and pressure gradients as set forth above, the radially inner portions of ligaments 363 and 367 tend to undergo more deformation (e.g., in directions 191 and 193 of FIG. 2) than do the radially outer portions of ligaments 363 and 367. Therefore, the anti-rotation surfaces of ring 350 that are radially inward (e.g., anti-rotation surface(s) 373) tend to undergo more deformation in directions 191 and 193 than do the anti-rotation surfaces of ring 350 that are radially outward (e.g., anti-rotation surface(s) 377). As a result, even when the engagement between anti-rotation surfaces 373 and 375 loosens due at least in part to high temperature creep, anti-rotation surfaces 377 and 381 remain firmly engaged due at least in part to the radially inward extension of anti-rotation surface(s) 381 from radially outer surface(s) 343 and/or 345. This facilitates ensuring that first end 354 does not rotate relative to ring 350 when ring 350 is subjected to high temperature creep, thus maintaining the interference fit amongst nozzles 353 to ensure the respective circumferential alignment of nozzles 353 during operation of rotary machine 100.

FIG. 7 is a schematic illustration of a portion of another alternative nozzle assembly 400 for use with HP section 102. In the exemplary embodiment, to facilitate inhibiting rotation of nozzle first end 454 when ligaments 463 and 467 respectively deform (e.g., in directions 191 and 193 shown in FIG. 2) in response to high temperature creep during operation of rotary machine 100, each nozzle 453 is provided with a coupling portion (or lug) 462 that extends from radially outer surface(s) 443 and/or 445 of respective hooks 458 and/or 460). Coupling portion 462 is formed integrally on first end 454, and coupling portion 462 may be formed via a variety of manufacturing processes known in the art, such as, but not limited to, a molding process, a drawing process, or a machining process. One or more types of materials may be used to fabricate coupling portion 462 and/or first end 454, with the materials selected based on suitability for one or more manufacturing techniques, dimensional stability, cost, moldability, workability, rigidity, and/or other characteristics of the material(s). For example, coupling portion 462 and/or first end 454 may be fabricated from a metal, such as an alloy steel and/or a nickel based material.

In the exemplary embodiment, each coupling portion 462 has a first end 464, a second end 466, and at least one anti-rotation surface 477 (e.g., a flat surface) that extends from at least one of radially outer surfaces 443 and 445, and between ends 464 and 466, along axis 471. First end 464 has a substantially planar end surface 470. The associated groove 452 of ring 450 includes a circumferentially extending notch 479 sized to receive coupling portion 462. Notch 479 has at least one anti-rotation surface 481 (e.g., a flat surface), and a substantially planar end surface 472 oriented substantially perpendicular to anti-rotation surface 481. When nozzle 453 is inserted into groove 452, coupling portion 462 is inserted into notch 479, such that coupling portion anti-rotation surface(s) 477 engage notch anti-rotation surface(s) 481 to form an anti-rotation feature 497 that extends radially outward from radially outer surface(s) 443 and/or 445 along axis 471. An attachment member 476 (e.g., a plate-shaped spacer) is inserted between surfaces 470 and 472 to bias nozzle 453 radially inward along a longitudinal axis 471 of nozzle 453 to seat first hook 458 and second hook 460 against rails 487 and 489 of respective ligaments 463 and 467 to facilitate maintaining a radial position of nozzle 453 during operation of rotary machine 100.

When ring 450 experiences high temperature creep in response to elevated temperatures and pressure gradients as set forth above, the radially inner portions of ligaments 463 and 467 tend to undergo more deformation (e.g., in directions 191 and 193) than do the radially outer portions of ligaments 463 and 467. Therefore, the anti-rotation surfaces of ring 450 that are radially inward (e.g., anti-rotation surface(s) 473) tend to undergo more deformation in directions 191 and 193 than do the anti-rotation surfaces of ring 450 that are radially outward (e.g., anti-rotation surface(s) 481). As a result, even when the engagement between anti-rotation surfaces 473 and 475 loosens due at least in part to high temperature creep, anti-rotation surfaces 477 and 481 remain firmly engaged due at least in part to the radially outward extension of anti-rotation surfaces 477 from radially outer surface(s) 443 and/or 445. This facilitates ensuring that first end 454 does not rotate relative to ring 450 when ring 450 is subjected to high temperature creep, thus maintaining the interference fit amongst nozzles 453 to ensure the respective circumferential alignment of nozzles 453 during operation of rotary machine 100.

The systems and methods described herein facilitate coupling a component within a rotary machine. More specifically, the systems and methods facilitate coupling a stationary nozzle within a groove of a ring in a rotary machine. For example, the systems and methods facilitate biasing the stationary nozzle radially inward to seat the stationary nozzle against rails of ring ligaments that define the groove. Moreover, the systems and methods facilitate coupling the stationary nozzle within the groove such that a radially outward end of the stationary nozzle is inhibited from rotating within the groove in response to a pre-twisting operation of the stationary nozzle. Particularly, the systems and methods facilitate providing an anti-rotation feature that extends from a radially outer surface of a nozzle hook, such that the ring ligaments are less susceptible to deformation at the anti-rotation feature, which in turn facilitates isolating the anti-rotation feature from high temperature creep associated with operation of the rotary machine. The systems and methods thus facilitate maintaining the pre-twisted state of the stationary nozzle during operation of the rotary machine, thereby maintaining the axial and radial orientation of the stationary nozzles collectively.

Exemplary embodiments of rotary machines are described above in detail. The systems and methods described herein are not limited to the specific embodiments described herein, but rather, components of the systems and methods may be utilized independently and separately from other components described herein. For example, the systems and methods described herein may have other applications not limited to turbine engines, as described herein. Rather, the systems and methods described herein can be implemented and utilized in connection with various other industries.

While the invention has been described in terms of various specific embodiments, those skilled in the art will recognize that the invention can be practiced with modification within the spirit and scope of the claims.

What is claimed is:

1. A rotary machine comprising:
a turbine section comprising a casing and a ring coupled within said casing, said ring comprising a groove; and
a nozzle coupled to said ring, wherein said nozzle comprises a first end, a second end, and an airfoil extending between said first end and said second end along a longitudinal axis, said first end comprising a first hook and a second hook, said first hook having a first radially outer surface, said second hook having a second radially outer surface, wherein said ring and said first end of said nozzle cooperate to form an anti-rotation feature that extends from at least one of said radially outer surfaces along said axis and between said hooks.

2. A rotary machine in accordance with claim 1, wherein said ring comprises a lug that extends into said groove, said lug comprising at least one anti-rotation surface of said anti-rotation feature.

3. A rotary machine in accordance with claim 2, wherein said first end of said nozzle comprises a notch, said notch comprising at least one anti-rotation surface of said anti-rotation feature, said anti-rotation surface of said lug engaging said anti-rotation surface of said notch.

4. A rotary machine in accordance with claim 1, wherein said ring comprises a notch, said notch comprising at least one anti-rotation surface of said anti-rotation feature.

5. A rotary machine in accordance with claim 4, wherein said first end of said nozzle comprises a lug, said lug comprising at least one anti-rotation surface of said anti-rotation feature, said anti-rotation surface of said lug engaging said anti-rotation surface of said notch.

6. A rotary machine in accordance with claim 1, wherein one of said ring and said nozzle comprises a lug, and wherein the other of said ring and said nozzle comprises a notch, said rotary machine further comprising a spacer inserted between said lug and said notch to bias said nozzle radially inward.

7. A rotary machine in accordance with claim 6, wherein said spacer is plate-shaped.

8. A rotary machine in accordance with claim 6, wherein said spacer is generally cylindrical.

9. A rotary machine in accordance with claim 1, wherein said rotary machine is a steam turbine engine.

10. A rotary machine in accordance with claim 9, wherein said turbine section is one of a high pressure turbine section, an intermediate pressure turbine section, and a low pressure turbine section.

11. A nozzle assembly for a rotary machine, said nozzle assembly comprising:
a ring comprising a groove; and
a nozzle coupled to said ring, wherein said nozzle comprises a first end, a second end, and an airfoil extending between said first end and said second end along a longitudinal axis, said first end comprising a first hook and a second hook, said first hook having a first radially outer surface, said second hook having a second radially outer surface, wherein said ring and said first end of said nozzle cooperate to form an anti-rotation feature that extends from at least one of said radially outer surfaces along said axis and between said hooks.

12. A nozzle assembly in accordance with claim 11, wherein said ring comprises a lug that extends into said groove, said lug comprising at least one anti-rotation surface of said anti-rotation feature.

13. A nozzle assembly in accordance with claim 12, wherein said first end of said nozzle comprises a notch, said notch comprising at least one anti-rotation surface of said anti-rotation feature, said anti-rotation surface of said lug engaging said anti-rotation surface of said notch.

14. A nozzle assembly in accordance with claim 11, wherein said ring comprises a notch, said notch comprising at least one anti-rotation surface of said anti-rotation feature.

15. A nozzle assembly in accordance with claim 14, wherein said first end of said nozzle comprises a lug, said lug comprising at least one anti-rotation surface of said anti-rotation feature, said anti-rotation surface of said lug engaging said anti-rotation surface of said notch.

16. A nozzle assembly in accordance with claim 11, wherein one of said ring and said nozzle comprises a lug, and wherein the other of said ring and said nozzle comprises a notch, said rotary machine further comprising a spacer inserted between said lug and said notch to bias said nozzle radially inward.

17. A nozzle assembly in accordance with claim 16, wherein said spacer is plate-shaped.

18. A nozzle for a rotary machine, said nozzle comprising:
a first end;
a second end; and
an airfoil extending between said first end and said second end along a longitudinal axis, said first end comprising a first hook and a second hook, said first hook having a first radially outer surface, said second hook having a second radially outer surface, wherein said first end comprises one of a lug and a notch having an anti-rotation surface extending from at least one of said first radially outer surface and said second radially outer surface along said axis and between said hooks.

19. A nozzle in accordance with claim 18, wherein said one of a lug and a notch has a substantially planar end surface.

20. A nozzle in accordance with claim 18, wherein said one of a lug and a notch has a substantially arcuate groove.
